(19) United States
(12) Patent Application Publication
(10) Pub. No.: US 2026/0003234 A1
(43) Pub. Date: Jan. 1, 2026

(54) INTELLIGENT REFLECTING SURFACE

(71) Applicant: Japan Display Inc., Tokyo (JP)

(72) Inventors: Daiichi SUZUKI, Tokyo (JP); Shinichiro OKA, Tokyo (JP); Mitsutaka OKITA, Tokyo (JP); Kazuki MATSUNAGA, Tokyo (JP)

(73) Assignee: Japan Display Inc., Tokyo (JP)

(21) Appl. No.: 19/318,600

(22) Filed: Sep. 4, 2025

Related U.S. Application Data
(63) Continuation of application No. PCT/JP2024/002227, filed on Jan. 25, 2024.

(30) Foreign Application Priority Data
Mar. 15, 2023 (JP) 2023-041093

(51) Int. Cl. G02F 1/1343

(52) U.S. Cl. CPC G02F 1/134318; G02F 1/134336; G02F 2203/02

(57) ABSTRACT

A reflecting device includes a patch electrode, a common electrode facing the patch electrode and separated from the patch electrode, and a liquid crystal layer between the patch electrode and the common electrode, wherein the patch electrode has a cross shape including a first rectangular pattern extending in a first direction and a second rectangular pattern extending in a second direction intersecting the first direction and intersecting the first rectangular pattern in a plan view, the common electrode has a first striped pattern extending in the first direction and a second striped pattern extending in the second direction and intersecting the first striped pattern in a plan view.

### CROSS-REFERENCE TO RELATED APPLICATIONS

This application is a Continuation of International Patent Application No. PCT/JP2024/002227, filed on Jan. 25, 2024, which claims the benefit of priority to Japanese Patent Application No. 2023-041093, filed on Mar. 15, 2023, the entire contents of each are incorporated herein by reference.

### FIELD

An embodiment of the present invention relates to a reflecting device.

### BACKGROUND

Phased array antenna devices control directivity by adjusting the amplitude and phase of high-frequency signals applied to each of a plurality of antenna elements arranged in a plane while the antenna is fixed in position. The phased array antenna devices require a phase shifter. The phased array antenna devices using a phase shifter that utilizes changes in a dielectric constant due to the alignment state of liquid crystals has been disclosed (For example, refer to Japanese laid-open patent publication No. H11-103201). Additionally, as an example of a device that reflects radio waves, a liquid crystal meta-surface reflector that can change the reflection direction of radio waves by utilizing the dielectric anisotropy of liquid crystals has been disclosed (For example, refer to Japanese laid-open patent publication No. 2019-530387).

In 5th-Generation Mobile Communication Systems (5G), which are becoming increasingly widespread, the application of radio wave reflecting devices is being considered in order to simplify radio wave base stations. Radio wave reflecting devices with a constant dielectric constant have a fixed radio wave reflection direction. On the other hand, as disclosed in Japanese laid-open patent publication No. 2019-530387, radio wave reflecting devices that use liquid crystal materials as dielectrics can change the radio wave reflection direction by applying voltage to the liquid crystal.

The electrodes of the radio wave reflecting device are opaque because they are made of metal, but the radio wave reflecting device is required to be able to reflect 5G radio waves in a desired direction without spoiling the scenery, and to have high reflection characteristics.

### SUMMARY

A reflecting device in an embodiment according to the present invention includes a patch electrode, a common electrode facing the patch electrode and separated from the patch electrode, and a liquid crystal layer between the patch electrode and the common electrode, wherein the patch electrode has a cross shape including a first rectangular pattern extending in a first direction and a second rectangular pattern extending in a second direction intersecting the first direction and intersecting the first rectangular pattern in a plan view, the common electrode has a first striped pattern extending in the first direction and a second striped pattern extending in the second direction and intersecting the first striped pattern in a plan view, the first rectangular pattern and the second rectangular pattern of the patch electrode overlap the common electrode, the patch electrode has a plurality of first through-holes in the first rectangular pattern and the second rectangular pattern, the common electrode has a second through-hole in the first striped pattern and the second striped pattern, and the first through-hole and the second through-hole overlap each other.

### BRIEF DESCRIPTION OF DRAWINGS

FIG. 1 shows a cross-sectional structure of a reflecting element utilized in a reflecting device according to an embodiment of the present invention.

FIG. 2 shows a plan view of a reflecting element utilized in a reflecting device according to an embodiment of the present invention.

FIG. 3 shows a plan view of a second substrate utilized in a reflecting device according to an embodiment of the present invention.

FIG. 4 shows a reflecting element utilized in a reflecting device according to an embodiment of the present invention.

FIG. 5 shows a plan view of a second substrate utilized in a reflecting device according to an embodiment of the present invention.

FIG. 6 shows a plan view of a reflecting element utilized in a reflecting device according to an embodiment of the present invention.

FIG. 7 shows a plan view of a second substrate utilized in a reflecting device according to an embodiment of the present invention.

FIG. 8A shows a diagram showing a state in which no voltage is applied between a patch electrode and a common electrode when a reflecting element utilized in a reflecting device according to an embodiment of the present invention operates.

FIG. 8B shows a diagram showing a state in which a voltage is applied between a patch electrode and a common electrode when a reflecting element utilized in a reflecting device according to an embodiment of the present invention operates.

FIG. 9 shows a plan view of a reflecting device according to an embodiment of the present invention.

FIG. 10 shows a plan view of a second substrate utilized in a reflecting device according to an embodiment of the present invention.

FIG. 11 shows a plan view of a second substrate utilized in a reflecting device according to an embodiment of the present invention.

FIG. 12 shows a schematic diagram showing a change in the traveling direction of a reflected wave by a reflecting device according to an embodiment of the present invention.

FIG. 13 shows a plan view of a reflecting device according to an embodiment of the present invention.

FIG. 14 shows a cross-sectional structure of a reflecting element in a reflecting device according to an embodiment of the present invention.

### DESCRIPTION OF EMBODIMENTS

Hereinafter, embodiments of the present invention are described with reference to the drawings. However, the present invention can be implemented in many different aspects, and should not be construed as being limited to the description of the following embodiments. For the sake of clarifying the explanation, the drawings may be expressed schematically with respect to the width, thickness, shape, and the like of each part compared to the actual aspect, but the drawings are only an example and do not limit the interpretation of the present invention. In this specification and each drawing, elements similar to those described previously with respect to previous drawings may be given the same reference sign (or a number followed by a, b, etc.) and a detailed description may be omitted as appropriate. The terms “first” and “second” appended to each element are a convenience sign used to distinguish them and have no further meaning except as otherwise explained.

As used herein, where a member or region is “on” (or “below”) another member or region, this includes cases where it is not only directly on (or just under) the other member or region but also above (or below) the other member or region, unless otherwise specified. That is, it includes the case where another component is included in between above (or below) other members or regions.

As used herein, a reflecting device (radio wave reflecting device) is also referred to as an IRS (Intelligent Reflecting Surface) or the like.

### 1. Reflecting Element

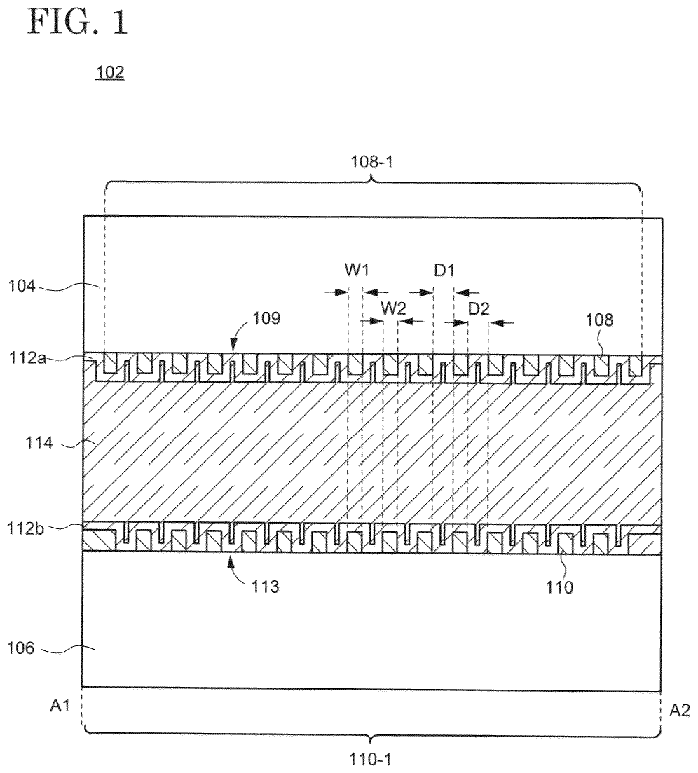

FIG. 1 shows an end view of a reflecting element 102 used in a reflecting device according to an embodiment of the present invention.

As shown in FIG. 1, the reflecting element 102 includes a first substrate 104 a second substrate 106, a patch electrode 108, a common electrode 110, a liquid crystal layer 114, an alignment film 112a, and an alignment film 112b. The patch electrode 108 is arranged on the first substrate 104, and the common electrode 110 is arranged on the second substrate 106. In the reflecting element 102, the first substrate 104, on which the patch electrode 108 is provided, is arranged on the plane of incidence of radio waves. The alignment film 112a is provided on the first substrate 104 so as to cover the patch electrode 108, and the alignment film 112b is provided on the second substrate 106 so as to cover the common electrode 110. The patch electrode 108 and the common electrode 110 are arranged to face each other, and are separated from each other. The common electrode 110 is arranged on the rear side of the patch electrode 108. The liquid crystal layer 114 is sandwiched between the patch electrode 108 and the common electrode 110. The alignment film 112a is arranged on the first substrate 104 between the patch electrode 108 and the liquid crystal layer 114 and the alignment film 112b is arranged on the second substrate 106 between the common electrode 110 and the liquid crystal layer 114.

The patch electrode 108 has a plurality of first through-holes 109. The common electrode 110 has a plurality of second through-holes 113 overlapping the plurality of first through-holes 109. For example, as shown in FIG. 1, the plurality of first through-holes 109 are arranged to overlap the plurality of second through-holes 113 in a cross-sectional view. The width W1 of the plurality of first through-holes 109 and the width W1 of the plurality of second through-holes 113 are equal or approximately equal. The plurality of first through-holes 109 can be arranged at equal distances D1. The plurality of second through-holes 113 are also equal in width to the plurality of first through-holes 109 and are further arranged to overlap, so that they can be arranged at equal distances D1.

As shown in FIG. 1, the plurality of first through-holes 109 and the plurality of second through-holes 113 overlap, and the width W1 of the plurality of first through-holes 109 and the width W1 of the plurality of second through-holes 113 are equal, so that visible light incident from the first substrate 104 and the second substrate 106 can pass through the plurality of first through-holes 109 and the plurality of second through-holes 113, and the translucency (transparency) of the reflective element 102 can be enhanced.

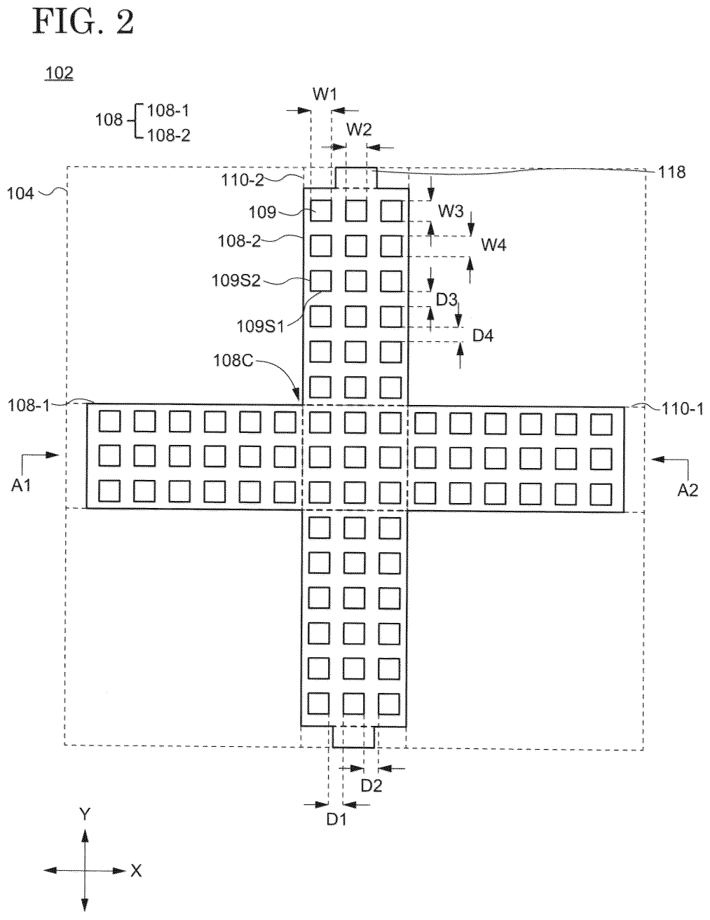

Referring now to FIG. 2, the patch electrode 108 is explained. FIG. 2 shows a plan view of the reflecting element 102 when viewed from above (the side where radio waves are incident). FIG. 1 shows a cross-sectional view between A1 and A2 shown in FIG. 2.

The patch electrode 108 should have a shape that is symmetrical with respect to the vertical and horizontal polarization of the incident radio wave and has a cross shape in a plan view. The cross shape of the patch electrode 108 includes a first rectangular pattern 108-1 extending in a first direction (e.g., the X-axis direction shown in FIG. 2) and a second rectangular pattern 108-2 extending in a second direction (e.g., the Y-axis direction shown in FIG. 2) that intersects the first direction and intersects the first rectangular pattern 108-1 at an intersection 108C. Here, the first direction shall be parallel to the vibration direction of the vertically or horizontally polarized wave, and the second direction shall be parallel to the vibration direction of the cross-polarized wave that intersects the vertically or horizontally polarized wave. The lengths of the first and second rectangular patterns 108-1 and 108-2 are set according to the wavelength of incident radio waves.

The patch electrode 108 has a plurality of first through-holes 109 in the first rectangular pattern 108-1 and the second rectangular pattern 108-2. The patch electrode 108 has a plurality of first through-holes 109 having a dot pattern. The plurality of first through-holes 109 are arranged along the first direction. The plurality of first through-holes 109 are arranged in a plurality of columns in the first rectangular pattern 108-1. The plurality of first through-holes 109 are arranged along the second direction. The plurality of first through-holes 109 are arranged in a plurality of columns in the second rectangular pattern 108-2. The first direction is different from and orthogonal to the second direction. FIG. 1 shows an example of a plurality of first through-holes 109 arranged in three rows each in the first and second directions, but the number of rows is not limited to the number above, as long as the first through-holes 109 are provided in the patch electrode 108.

The plurality of first through-holes 109 can be arranged at an equal distance in the first direction. For example, as shown in FIG. 2, the distance D1 and the distance D2 of the plurality of first through-holes 109 arranged in the first direction can be equal or approximately equal. The plurality of first through-holes 109 can be arranged at an equal distance in the second direction. For example, as shown in FIG. 2, the distance D3 and the distance D4 of the plurality of first through-holes 109 arranged in the second direction can be equal or approximately equal.

As mentioned above, the widths of the plurality of first through-holes 109 can be equal. For example, as shown in FIG. 2, the widths W1 and W2 of the first through-holes 109 in the first direction can be equal or approximately equal. In the second direction, the width W3 and the width W4 of the first through-hole 109 can be equal or approximately equal.

The plurality of first through-holes 109 are holes that pass through the patch electrode 108 and can take various shapes in a plan view. FIG. 2 shows an example where the plurality of first through-holes 109 are square in a plan view. The shape of the plurality of first through-holes 109 in a plan view is not limited to a square, but may be rectangular, circular, oval, or hexagonal, or other polygonal shapes with a corner number greater than 4.

When the plurality of first through-holes 109 are rectangular in a plan view, the shape of the plurality of first through-holes 109 includes a first side 109S1 and a second side 109S2. The first side 109S1 is parallel or approximately parallel to the direction in which the first rectangular pattern 108-1 extends. The first side 109S1 is preferably parallel or approximately parallel to the polarization. The second side 109S2 is parallel or approximately parallel to the direction in which the second rectangular pattern 108-2 extends. The second side 109S2 is preferably parallel or approximately parallel to the polarization.

From the above, the patch electrode 108 can have a high aperture ratio by having the plurality of first through-holes 109. The patch electrode 108 has high translucency (transparency) by having a high aperture ratio. The aperture ratio of the patch electrode 108 indicates the ratio of the area of the opening by the first through-hole 109 per area of the patch electrode 108.

The patch electrode 108 has the plurality of first through-holes 109 to improve the appearance of the vertical and horizontal stripes of the patch electrode 108. Furthermore, when the first side 109S1 and the second side 109S2 of the first through-hole 109 are parallel or approximately parallel to the direction in which the first rectangular pattern 108-1 extends and the direction in which the second rectangular pattern 108-2 extends, respectively, the patch electrode 108 can have higher reflective characteristics for radio waves.

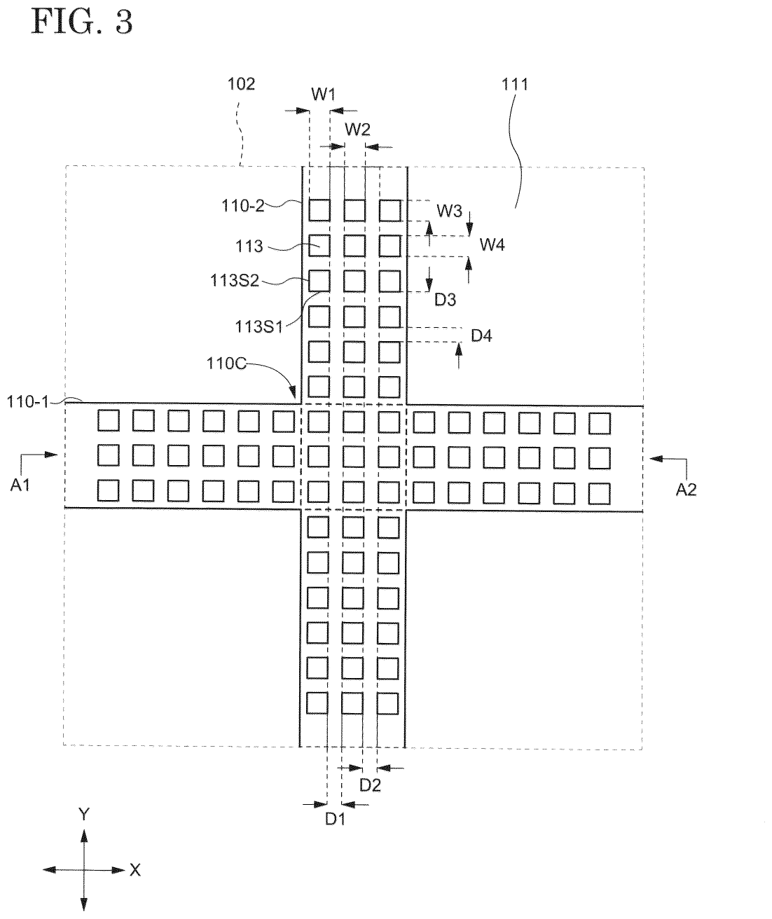

Referring now to FIG. 3, the common electrode 110 with a second through-hole 113 that overlaps the first through-hole 109 is explained. FIG. 3 shows a plan view of the second substrate in a reflecting device according to one embodiment of the present invention. Specifically, FIG. 3 shows the common electrode 110 corresponding to one reflecting element 102.

The common electrode 110 has an opening 111 outside the area overlapping the patch electrode 108. Thus, the common electrode 110 has a cross shape in the reflecting element 102. In other words, the first striped pattern 110-1 extending in the first direction (Y-axis direction shown in FIG. 3) and the second striped pattern 110-2 extending in the second direction (X-axis direction shown in FIG. 3) intersect at the intersection 110C.

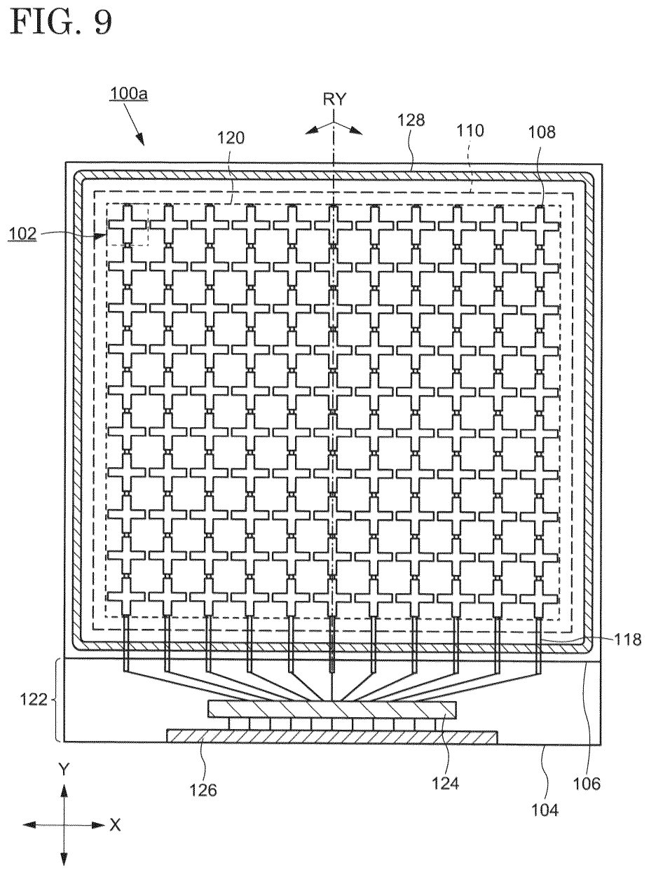

The cross shape of the common electrode 110 overlaps the cross shape of the patch electrode 108. As shown in the cross-sectional view in FIG. 1, the first striped pattern 110-1 overlaps the first rectangular pattern 108-1. The second striped pattern 110-2 similarly overlaps the second rectangular pattern 108-2 in the cross-sectional view. When the reflecting elements 102 are arranged in a matrix, the patch electrodes 108 are arranged individually and independently, whereas the common electrodes 110 are connected in a matrix arrangement to form a single grid pattern. That is, the first striped pattern 110-1 shown in FIG. 3 is part of the first striped pattern 110-1 in the reflecting device shown in FIG. 9, and the second striped pattern 110-2 is part of the second striped pattern 110-2 shown in FIG. 9.

The common electrode 110 has a first striped pattern 110-1 and a second striped pattern 110-2 with the plurality of second through-holes 113. The common electrode 110 has the plurality of second through-holes 113 with a dot pattern. The plurality of second through-holes 113 having a dot pattern are arranged in a plurality of columns in the first striped pattern 110-1 and the second striped pattern 110-2. FIG. 3 shows an example of the single first striped pattern 110-1 and the second striped pattern 110-2 with the plurality of second through-holes 113 in three rows, but this number of rows is not limited.

The plurality of second through-holes 113 overlap the plurality of first through-holes 109, as shown in FIG. 1. Therefore, the distance between the plurality of adjacent second through-holes 113 can be equal or approximately equal. For example, as shown in FIG. 3, the distance D1 and the distance D2 of the plurality of second through-holes 113 arranged in the first direction can be equal or approximately equal. The plurality of second through-holes 113 can be arranged at equal distances in the second direction. For example, as shown in FIG. 3, the distance D3 and the distance D4 of the plurality of second through-holes 113 arranged in the second direction can be equal or approximately equal.

The plurality of second through-holes 113 can be equal or approximately equal in shape and area to the plurality of first through-holes 109. The plurality of second through-holes 113 can be rectangular in a plan view. The shape of the plurality of second through-holes 113 includes a first side 113S1 and a second side 113S2. The first side 113S1 is parallel or approximately parallel to the direction in which the first striped pattern 110-1 extends. The second side 113S2 is parallel or approximately parallel to the direction in which the second striped pattern 110-2 extends. The lengths of the first side 113S1 and the second side 113S2 can be equal or approximately equal. For example, as shown in FIG. 3, the lengths of the first side 113S1 and the second side 113S2 can be equal and the shape of the plurality of second through-holes 113 can be square. The shape of the plurality of second through-holes 113 in a plan view should be equal to the shape of the first through-hole 109, and is not limited to square, but may be rectangular, circular, oval, or hexagonal, or other polygonal shapes with a corner number greater than 4, such as hexagons.

The common electrode 110 has a plurality of second through-holes 113 and a plurality of openings 111 to increase the aperture ratio of the common electrode 110 and to increase the translucency (transparency) of the common electrode 110. The common electrode 110 has a plurality of second through-holes 113 to improve the appearance of the vertical and horizontal stripes of the common electrode 110. Furthermore, when the first side 113S1 of the second through-hole 113 is parallel or approximately parallel to the direction in which the first striped pattern 110-1 extends, and the second side 113S2 is parallel or approximately parallel to the direction in which the second striped pattern 110-2 extends, the common electrode 110 can have improved reflection characteristics for radio waves.

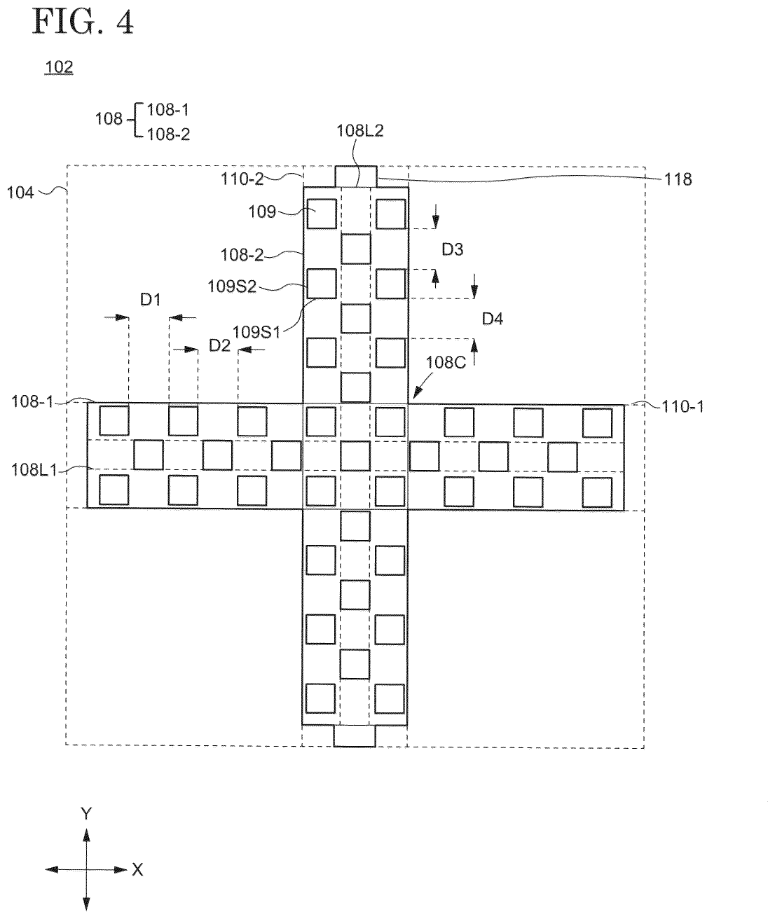

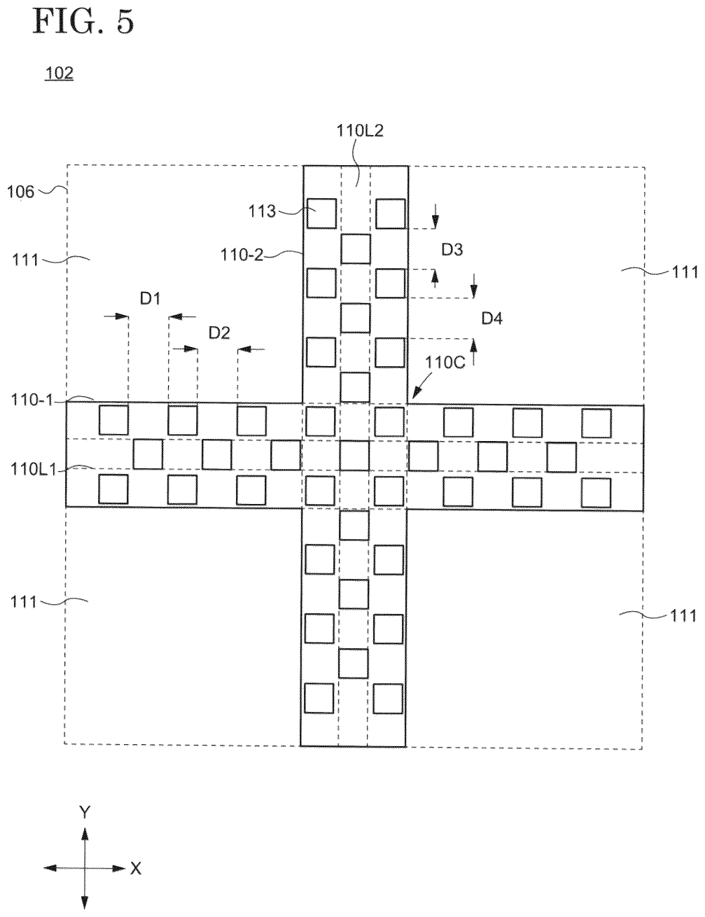

The shape and arrangement of the plurality of first through-holes 109 in the patch electrode 108 and the plurality of second through-holes 113 in the common electrode 110 can be different, as described above. Referring to FIGS. 4 and 5, the shape and arrangement of the plurality of first through-holes 109 and plurality of second through-holes 113 are explained.

The plurality of first through-holes 109 can be alternately arranged on the patch electrodes 108. FIGS. 4 and 5 show a plan view of a reflecting element used in a reflecting device.

The plurality of first through-holes 109 can be arranged to form a checkered pattern. For example, as shown in FIG. 4, the plurality of first through-holes 109 can be arranged on diagonals. Since the plurality of first through-holes 109 are arranged on the diagonal, the first rectangular pattern 108-1 and the second rectangular pattern 108-2 are divided by the plurality of first through-holes 109. For example, as shown in FIG. 4, when a straight-line portion 108L1 of the first rectangular pattern 108-1 is between the plurality of first through-holes 109 adjacent to each other in the second direction, the patch electrode 108 of the straight-line portion 108L1 is divided by the plurality of first through-holes 109. Similarly for the second rectangular pattern 108-2, the second rectangular pattern 108-2 is divided by the plurality of first through-holes 109. For example, as shown in FIG. 4, when the straight-line portion 108L2 of the second rectangular pattern 108-2 is between the plurality of first through-holes 109 adjacent to each other in the first direction, the patch electrode 108 of the straight-line portion 108L2 is divided by the plurality of first through-holes 109. The plurality of second through-holes 113 are arranged alternately on the common electrode 110. The plurality of second through-holes 113 are arranged to form a checkered pattern. For example, as shown in FIG. 5, the plurality of second through-holes 113 are arranged on diagonals.

The plurality of second through-holes 113 are arranged alternately in the common electrode 110. The plurality of second through-holes 113 are arranged to form a checkered pattern. For example, as shown in FIG. 5, the plurality of second through-holes 113 are arranged on diagonals. As the plurality of second through-holes 113 are arranged on diagonals, the first striped pattern 110-1 and the second striped pattern 110-2 are divided by the plurality of second through-holes 113. For example, as shown in FIG. 5, when the straight-line portion 110L1 of the first striped pattern 110-1 is between the plurality of adjacent second through-holes 113 in the second direction, the common electrode 110 of the straight-line portion 110L1 is divided by the plurality of second through-holes 113. Similarly for the second striped pattern 110-2, the second striped pattern 110-2 is divided by the plurality of second through-holes 113. For example, as shown in FIG. 5, when the straight-line portion 110L2 of the second striped pattern 110-2 is between the plurality of adjacent second through-holes 113 in the first direction, the common electrode 110 of the straight-line portion 110L2 is divided by the plurality of second through-holes 113.

The appearance of the vertical and horizontal stripes is further improved when the plurality of first through-holes 109 and plurality of second through-holes 113 are arranged to form a checkered pattern.

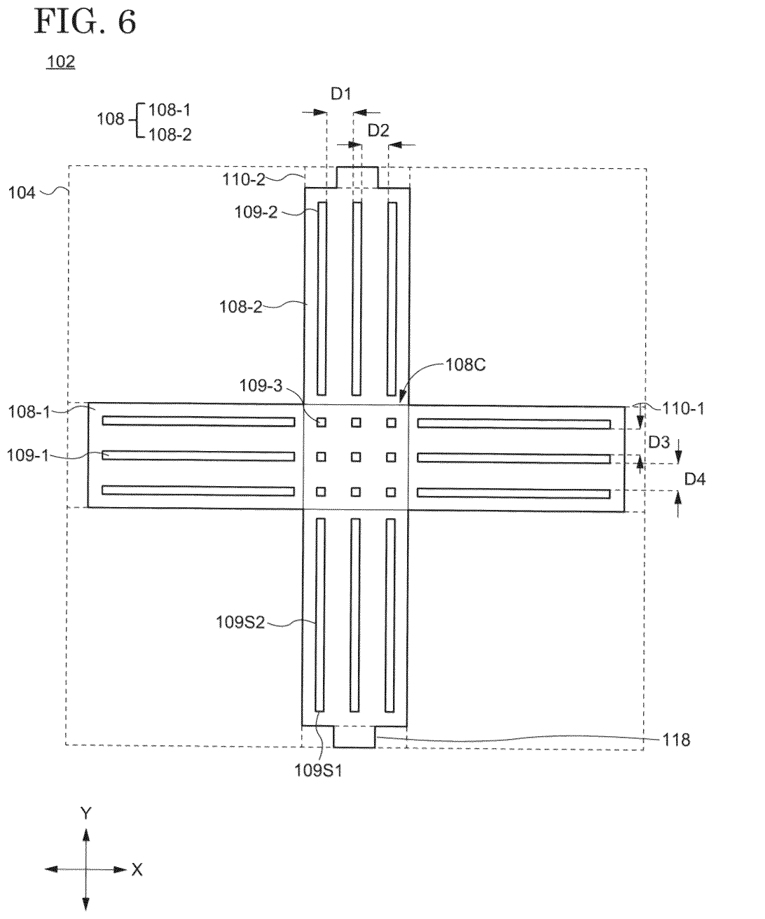

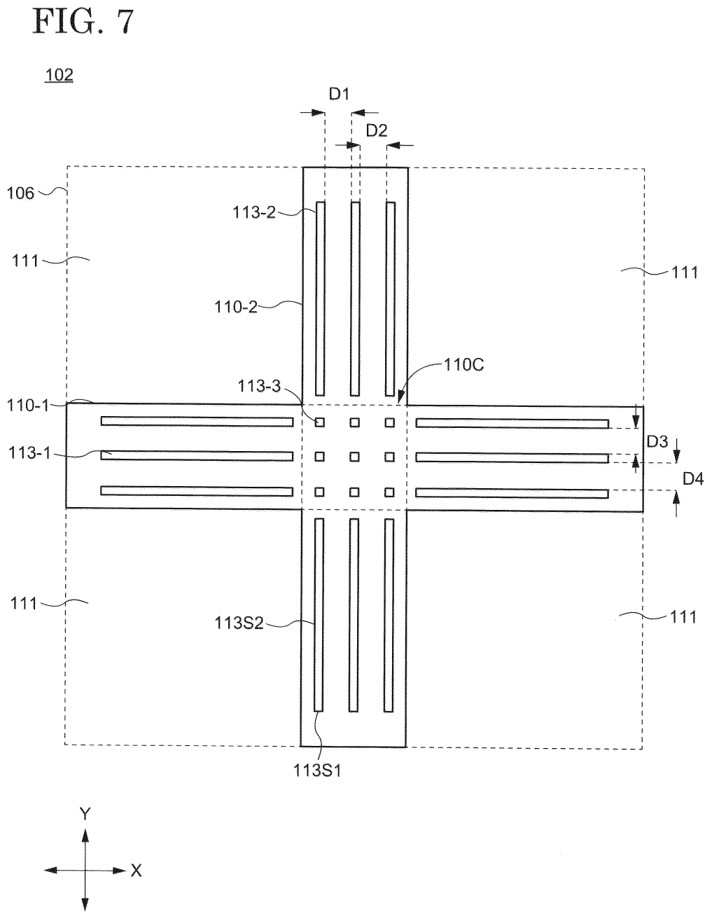

Referring to FIGS. 6 and 7, the shapes and arrangements of the plurality of first through-holes 109 and plurality of second through-holes 113, which differ from the shapes and arrangements described above, are explained. FIGS. 6 and 7 show a plan view of a reflecting element used in a reflecting device.

The plurality of first through-holes 109 have a slit-shaped pattern 109-1 extending along the first rectangular pattern 108-1 and a slit-shaped pattern 109-2 extending along the second rectangular pattern 108-2. The slit-shaped pattern 109-1 is opened in the patch electrode 108 so that it is longer with respect to the longitudinal direction of the first rectangular pattern 108-1, as shown in FIG. 6. The slit-shaped pattern 109-2 is opened in the patch electrode 108 so that it is longer with respect to the longitudinal direction of the second rectangular pattern 108-2.

The plurality of first through-holes 109 have a plurality of dot patterns 109-3 at the intersection 108C of the first rectangular pattern 108-1 and the second rectangular pattern 108-2. The shape of the dot pattern 109-3 differs from that of the slit-shaped pattern 109-2, as shown in FIG. 6, and can be, for example, a square with equal lengths on all four sides. The dot pattern 109-3 is opened on the patch electrode 108 with a smaller area than the slit-shaped pattern 109-2.

The plurality of second through-holes 113 have a slit-shaped pattern 113-1 extending along the first striped pattern 110-1 and a slit-shaped pattern 113-2 extending along the second striped pattern 110-2. The slit-shaped pattern 113-1 is opened in the common electrode 110 so that it is longer with respect to the longitudinal direction of the first striped pattern 110-1, as shown in FIG. 7. The slit-shaped pattern 113-2 is opened in the common electrode 110 so that it is longer with respect to the longitudinal direction of the second striped pattern 110-2.

The plurality of second through-holes 113 have a plurality of dot patterns 113-3 at the intersection 110C of the first striped pattern 110-1 and the second striped pattern 110-2. The shape of the dot pattern 113-3 differs from that of the slit-shaped pattern 113-2, and can be, for example, a square with equal lengths on all four sides.

By providing the patch electrode 108 and the common electrode 110 with through-holes having a plurality of slit-shaped patterns, and also with through-holes having a plurality of dot patterns, the reflecting device can further increase the amount of phase change and obtain even higher reflection characteristics.

Referring again to FIG. 1, the main configuration of the reflecting element 102 is explained here.

The first substrate 104 and the second substrate 106 are bonded together by a sealant described later (see FIG. 6). The first substrate 104 and the second substrate 106 are oppositely arranged with a gap therebetween, and the liquid crystal layer 114 is provided within an area surrounded by a sealing material. The liquid crystal layer 114 is provided so as to fill the gap between the first substrate 104 and the second substrate 106. A distance between the first substrate 104 and the second substrate 106 is 30 to 100 μm, for example, a distance of 50 μm in this case. Since the patch electrode 108, the common electrode 110, the alignment film 112a, and the alignment film 112b are disposed between the first substrate 104 and the second substrate 106, the distance between the alignment film 112a and the alignment film 112b disposed on each of the first substrate 104 and the second substrate 106 is precisely the thickness of the liquid crystal layer 114. Although not shown in FIG. 1, a spacer may be disposed between the first substrate 104 and the second substrate 106 to keep the distance constant.

A control signal is applied to the patch electrode 108 to align liquid crystal molecules in the liquid crystal layer 114. The control signal is a DC voltage signal or a polarity inversion signal in which positive and negative DC voltages are alternately inverted. The common electrode 110 is applied with a ground voltage (common) or at an intermediate level of the polarity inversion signal. When the control signal is applied to the patch electrode 108, the alignment state of the liquid crystal molecules contained in the liquid crystal layer 114 is changed.

A material that reflects visible light can be used for the patch electrode 108 and the common electrode 110. A metal material having a small specific resistance can be used as the material for forming the patch electrode 108. For example, a metal film such as aluminum (Al) or copper (Cu) can be used as the material for forming the common electrode 110.

Liquid crystal materials having dielectric constant anisotropy are used for the liquid crystal layer 114. For example, nematic, smectic, cholesteric, and discotic liquid crystals are used as the liquid crystal layer 114. The liquid crystal layer 114 with dielectric constant anisotropy has a dielectric constant that changes due to changes in the alignment state of the liquid crystal molecules. The reflecting element 102 can change the dielectric constant of the liquid crystal layer 114 by the control signal applied to the patch electrode 108, thereby delaying the phase of the reflected wave when radio waves are reflected.

The frequency bands of radio waves reflected by the reflecting element 102 are the very short wave (VHF) band, ultra short wave (UHF) band, microwave (SHF) band, submillimeter wave (THF), and millimeter wave (EHF) band. Although the liquid crystal molecules in the liquid crystal layer 114 align themselves in response to the control signal applied to the patch electrode 108, they hardly follow the frequency of the radio waves irradiated to the patch electrode 108. Therefore, the reflecting element 102 can control the phase of the reflected radio waves without being affected by radio waves.

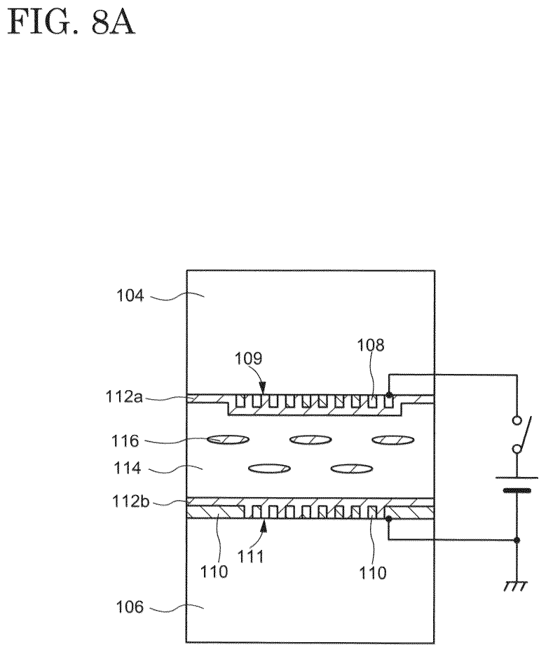

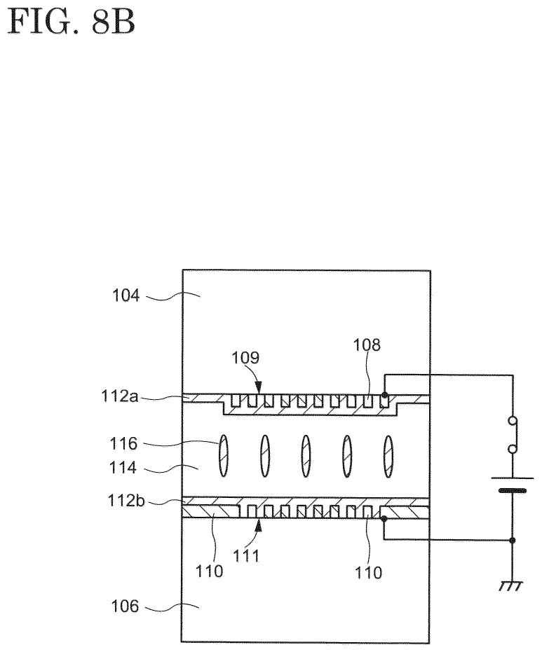

Next, referring to FIGS. 8A and 8B, the alignment state of the liquid crystal layer 114 when a voltage is applied to the patch electrode 108 and the common electrode 110 of the reflecting element 102 will be described.

FIG. 8A shows a state (“first state”) in which a voltage is not applied between the patch electrode 108 and the common electrode 110. FIG. 8A shows an example where the alignment film 112a and the alignment film 112b are horizontally aligned films. The long axis of the liquid crystal molecules 116 in the first state is aligned horizontally with respect to the surfaces of the patch electrode 108 and the common electrode 110 by the alignment film 112a and the alignment film 112b. FIG. 8B shows a state (“second state”) in which a control signal (voltage signal) is applied to the patch electrode 108. The liquid crystal molecules 116 are aligned in the second state with the long axis perpendicular to the surfaces of the patch electrode 108 and the common electrode 110 under the effect of the electric field. According to the magnitude of the control signal applied to the patch electrode 108 (magnitude of the voltage between the counter electrode and the patch electrode), it is possible to align the angle at which the long axis of the liquid crystal molecules 116 is aligned in an intermediate direction between the horizontal and vertical directions.

When the liquid crystal molecules 116 have positive dielectric constant anisotropy, the dielectric constant is larger in the second state relative to the first state. When the liquid crystal molecules 116 have negative dielectric constant anisotropy, the dielectric constant is smaller in the second state relative to the first state. The liquid crystal layer 114 having dielectric anisotropy can be regarded as a variable dielectric layer. The reflecting element 102 can be controlled to delay (or not) the phase of the reflected wave by using the dielectric constant anisotropy of the liquid crystal layer 114.

According to this embodiment, the patch electrode 108 has a plurality of first through-holes 109 in the cross shape including the first rectangular pattern 108-1 extending in the first direction and the second rectangular pattern 108-2 extending in the second direction intersecting the first direction and intersecting the first rectangular pattern 108-1, and the common electrode 110 has the plurality of second through-holes 113 in the first striped pattern 110-1 and the second striped pattern 110-2, and the plurality of first through-holes 109 and the plurality of second through-holes 113 overlap each other, thereby achieving high light transmittance, a large amount of phase change, and further improving the appearance of vertical and horizontal stripes.

### 2. Reflecting Device

Next, the structure of the reflecting device in which the reflecting elements are integrated is shown.

### 2-1. Reflecting Device A (Uniaxial Reflection Control)

FIG. 9 shows a configuration of a reflecting device 100a according to an embodiment of the present invention. The reflecting device 100a includes a reflector 120. The reflector 120 is configured with a plurality of reflecting elements 102. The plurality of reflecting elements 102 are arranged, for example, in a first direction (X-axis direction shown in FIG. 9) and in a second direction (Y-axis direction shown in FIG. 9) that intersects the first direction. The plurality of reflecting elements 102 are arranged so that the patch electrodes 108 face the plane of incidence of radio waves. The reflector 120 is flat, and the plurality of patch electrodes 108 are arranged in this flat plane in a matrix.

The reflecting device 100 has a structure in which the plurality of reflecting elements 102 are integrated on a single first substrate 104. As shown in FIG. 9, the reflecting device 100 has a structure in which a first substrate 104 with an array of the plurality of patch electrodes 108 and the second substrate 106 with the common electrode 110 are arranged on top of each other, and the liquid crystal layer (not shown) is disposed between the two substrates. The reflector 120 is formed in the region where the plurality of patch electrodes 108 and the common electrode 110 are superimposed. A cross-sectional structure of the reflector 120 is the same as that of the reflecting element 102 shown in FIG. 2 when viewed with respect to the individual patch electrodes 108. The first substrate 104 and the second substrate 106 are bonded to each other by the sealant 128, and the liquid crystal layer, not shown, is disposed in the region inside the sealant 128.

The first substrate 104 has a peripheral area 122 that extends outward from the second substrate 106 in addition to the area that faces the second substrate 106. The peripheral region 122 is disposed with a first driver circuit 124 and a terminal part 126. The first driver circuit 124 outputs control signals to the patch electrode 108. The terminal part 126 is a region that forms a connection with an external circuit, for example, a connected flexible printed circuit board, not shown. Signals for controlling the first driver circuit 124 are input to the terminal part 126.

As described above, the plurality of patch electrodes 108 is arranged on the first substrate 104 in the first (X-axis) and the second (Y-axis) directions. A plurality of first wirings 118 extending in the second direction (Y-axis direction) are arranged on the first substrate 104. Each of the plurality of first wirings 118 is electrically connected to the plurality of patch electrodes 108 arranged in the second direction (Y-axis direction). In other words, the plurality of patch electrodes 108 arranged in the second direction (Y-axis direction) are connected by the first wiring 118. The reflector 120 has a configuration of a plurality of patch electrode arrays in a single row connected by the first wiring 118 in the first direction (X-axis direction). FIG. 9 shows an example in which the patch electrodes 108 are connected for each array in the first direction (Y-axis direction).

The plurality of first wirings 118 arranged on the reflector 120 extend to the peripheral region 122 and are connected to the first driver circuit 124. The first driver circuit 124 outputs control signals to be applied to the patch electrode 108. The first driver circuit 124 can output control signals of different voltage levels to each of the plurality of first wirings 118. As a result, the control signal is applied to the plurality of patch electrodes 108 arranged in the first (X-axis) and second (Y-axis) directions in the reflector 120, row by row (for each patch electrode 108 arranged in the second direction (Y-axis)).

The second substrate 106 is provided with a common electrode 110 in a shape that extends over the entire area in the second substrate 106 so that it overlaps the plurality of patch electrodes 108. As shown in FIG. 9, the common electrode 110 is formed to have a larger area than the patch electrodes 108.

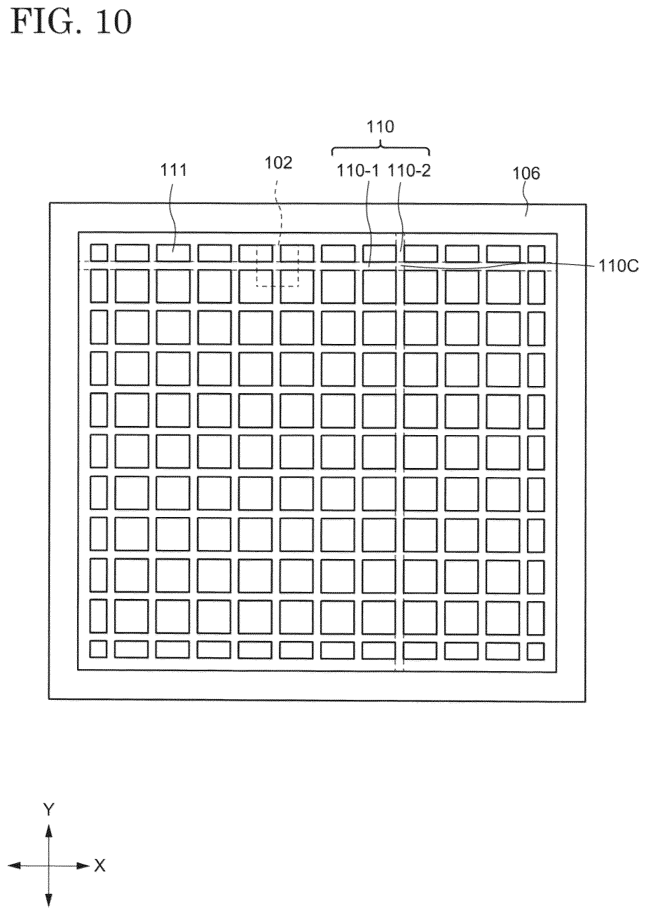

Referring to FIG. 10, the common electrode 110 provided in the second substrate 106 is described. Note that the plurality of second through-holes 113 in the common electrode 110 are omitted in FIG. 10.

The common electrode 110 has a plurality of first striped patterns 110-1 extending in the first direction and a plurality of second striped patterns 110-2 extending in the second direction. Since the common electrode 110 and the patch electrode 108 are arranged to overlap each other, the intersection 110C of the first striped pattern 110-1 extending in the first direction and the second striped pattern 110-2 extending in the second direction overlaps the intersection 108C of the patch electrode 108. Thus, as described above, the cross shape of the common electrode 110 overlaps the cross shape of the patch electrode 108. The cross shape of the common electrode 110 and the cross shape of the patch electrode 108 can have sides that are parallel or approximately parallel to the polarization. In addition, the cross shape of the common electrode 110 and the cross shape of the patch electrode 108 should be subject to rotation. The cross shape of the common electrode 110 and the cross shape of the patch electrode 108, which overlap each other, have sides that are parallel or approximately parallel to the polarization and are subject to rotation, allowing the reflecting element 102 to have high reflective properties for radio waves.

The common electrode 110 has a plurality of openings 111 as described above. The common electrode 110 has a plurality of openings 111 that form a mesh pattern. In other words, the plurality of openings 111 are arranged in a matrix on the second substrate 106. The plurality of openings 111 are arranged so that they do not overlap the patch electrode 108.

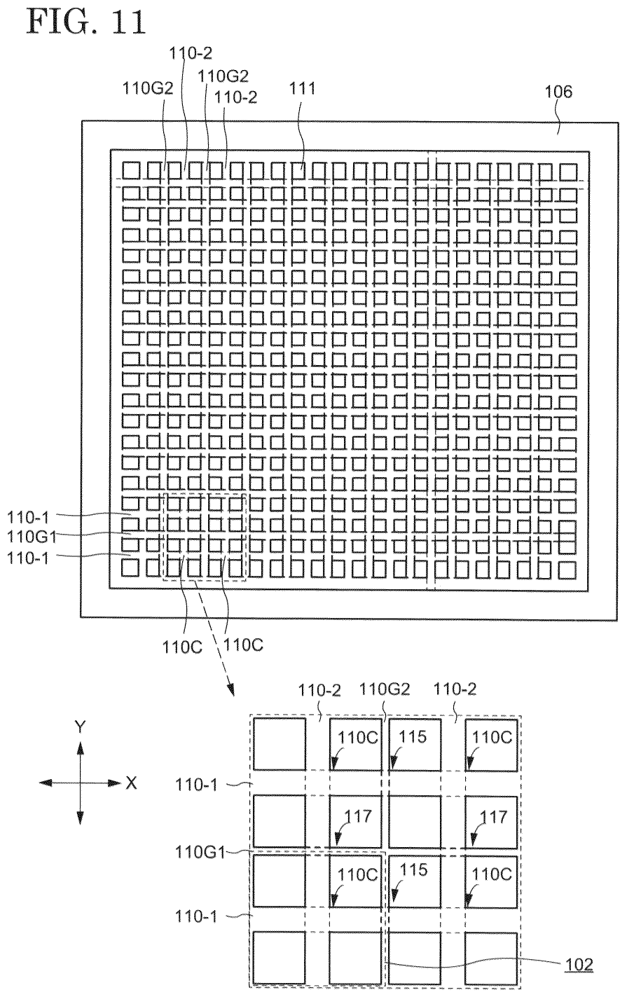

Referring to FIG. 11, a common electrode 110 with a different shape than the common electrode shown in FIG. 10 is explained. FIG. 11 shows a plan view of the second substrate used in a reflecting device and an enlarged inset view of the arrangement of the common electrodes 110 corresponding to the four reflecting elements 102. In FIG. 11, the plurality of second through-holes 113 in the common electrodes 110 are omitted.

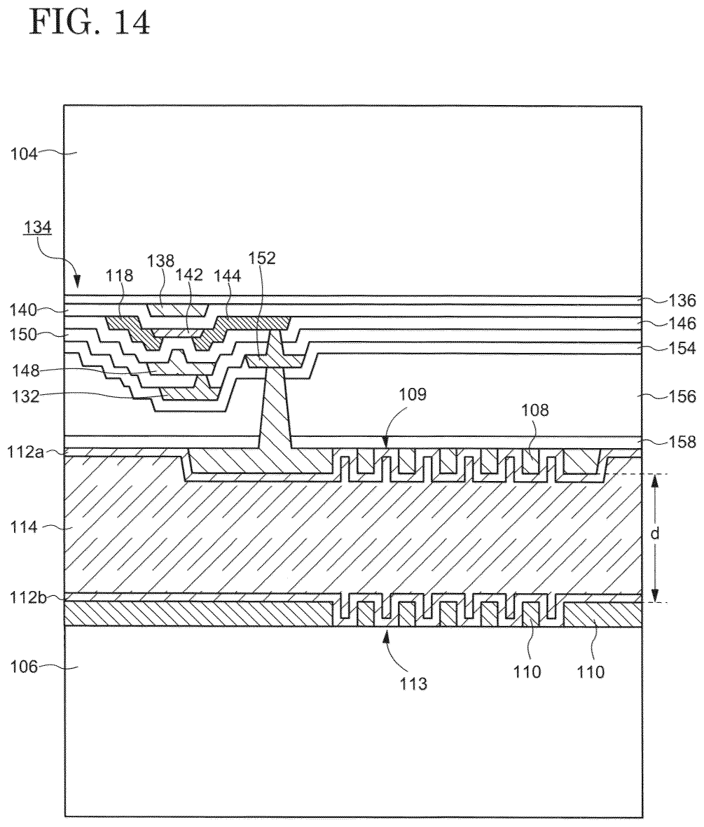

The common electrodes 110 can have a grid pattern in a plan view. The grid pattern is arranged to surround the cross shape common electrode 110, which corresponds to one reflecting element 102. For example, as shown in FIG. 14, the grid pattern has a first straight-line pattern 110G1 extending in the first direction and a second straight-line pattern 110G2 extending in the second direction. The first straight-line pattern 110G1 intersects the second striped pattern 110-2 at the intersection 117. The second straight-line line pattern 110G2 intersects the first striped pattern 110-1 at the intersection 115. The intersection 115 is located between the plurality of intersections 110C where the plurality of first striped patterns 110-1 and the plurality of second striped patterns 110-2 intersect. As shown in FIG. 11, the intersection 115 is located between the plurality of intersections 110C aligned in the first direction.

By further providing the grid pattern on the common electrode 110, the phase change of the reflecting device can be further increased, and even higher reflection characteristics can be obtained.

The first striped pattern 110-1 and the second striped pattern 110-2 in FIGS. 10 and 11 are interconnected with the first striped pattern 110-1 and the second striped pattern 110-2 shown in FIG. 3. As mentioned above, the common electrode 110 in FIGS. 10 and 11 is illustrated with the plurality of second through-holes 113 omitted.

A control signal is applied to each pair of the plurality of patch electrodes 108 arranged in the second direction (Y-axis direction) in the reflecting device 100a. Thereby, the direction of reflection of the reflected wave of a radio wave incident on the reflector 120 can be controlled. That is, the reflecting device 100a can control the direction of travel of the reflected wave in the left and right directions on the drawing with respect to the reflection axis RY, which is parallel to the second direction (Y-axis direction), of the radio wave irradiated on the reflector 120.

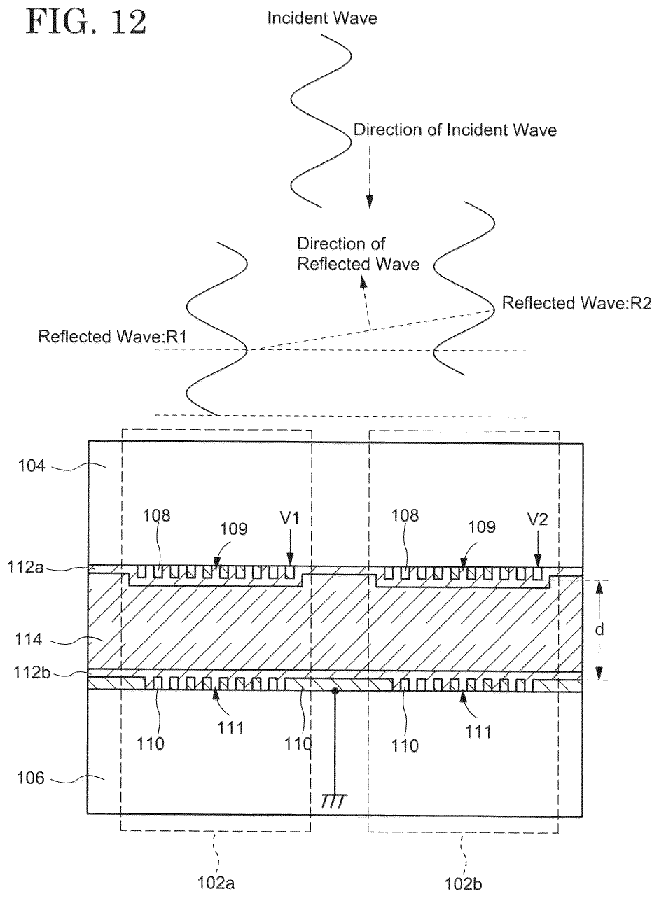

FIG. 12 schematically shows that the direction of travel of the reflected wave is changed by the two reflecting elements 102. In the case where radio waves are incident on the first reflecting element 102a and the second reflecting element 102b at the same phase, since different control signals (V1≠V2) are applied to the first reflecting element 102a and the second reflecting element 102b, the phase change of the reflected wave by the second reflecting element 102b is larger than that of the first reflecting element 102a. As a result, the phase of the reflected wave R1 reflected by the first reflecting element 102a and the phase of the reflected wave R2 reflected by the second reflecting element 102b differ (in FIG. 7, the phase of the reflected wave R2 is more advanced than that of the reflected wave R1), and the apparent traveling direction of the reflected wave changes obliquely.

In FIG. 7, since the plurality of patch electrodes 108 arranged in the second direction (Y-axis direction) are electrically connected by the first wiring 118 and are electrically equipotential, it is also possible to replace it with a strip electrode continuous in the second direction (Y-axis direction) instead of a plurality of divided shapes. However, since the dimensions of the patch electrode 108 have an appropriate range depending on the wavelength of the reflected radio wave, when it is made into a strip electrode, the sensitivity to the target wavelength is reduced and the behavior towards the vertical polarization wave and horizontal polarization wave is different. Therefore, as mentioned above, it is preferable to arrange the patch electrodes 108 in an array having a cross shape that is symmetrical with respect to a vertical polarization wave and a horizontal polarization wave and to connect the plurality of patch electrodes 108 that are arranged parallel to the reflection axis RY by the first wiring 118.

### 2-2. Reflecting Device B (Biaxial Reflection Control)

Since the reflecting device 100a has a single reflection axis RY, the reflection angle can be controlled in a direction with the reflection axis RY as the axis of rotation. In contrast, this embodiment shows an example of a reflecting device 100b that is capable of biaxial reflection control.

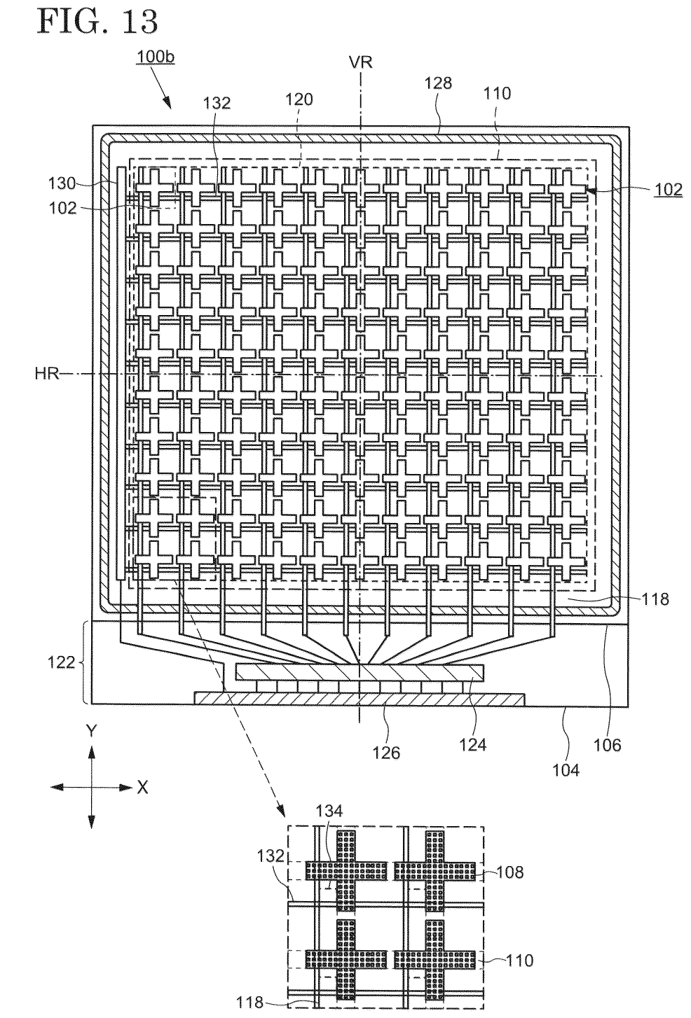

FIG. 13 shows the configuration of the reflecting device 100b. The following description will focus on the differences from the reflecting device 100a shown in FIG. 9.

The reflecting device 100b has a plurality of second wirings 132 extending in the first direction (X-axis direction) in addition to a plurality of first wirings 118 extending in the second direction (Y-axis direction) in the reflector 120. The plurality of first wirings 118 and the plurality of second wirings 132 are arranged to intersect across an insulating layer not shown in the diagram. The plurality of first wirings 118 are connected to a first driver circuit 124, and the plurality of second wirings 132 are connected to a second driver circuit 130. The first driver circuit 124 outputs control signals and the second driver circuit 130 outputs scanning signals.

FIG. 13 shows an enlarged inset of the arrangement of the four patch electrodes 108, the first wirings 118 and the second wirings 132. Each of the four patch electrodes 108 is disposed with a switching element 134. Each of the four patch electrodes 108 is electrically connected to the switching element 134. Switching (on and off) of the switching element 134 is controlled by the scanning signal applied to the second wiring 132. A control signal is applied from the first wiring 118 to the patch electrode 108 where the switching element 134 is turned on. The switching element 134 is formed, for example, by a thin-film transistor. According to this configuration, the plurality of patch electrodes 108 arranged in the first direction or a row direction (X-axis direction) can be selected row by row, and control signals of different voltage levels can be applied to each row. FIG. 13 shows an example in which the patch electrodes 108 are connected to the second wiring 132 and switching elements 134 arranged in the first direction or each row (X-axis direction) via the switching elements 134 arranged for each patch electrode 108, and the patch electrodes 108 are selected row by row, and control signals with different voltage levels are applied to each row.

The reflecting device 100b shown in FIG. 13 can control the direction of travel of the reflected wave in the left and right directions on the drawing, centered on the reflection axis VR parallel to the second direction (Y-axis direction), when the radio wave is irradiated on the reflector 120, furthermore, the direction of travel of the reflected wave can also be controlled in the vertical direction on the drawing, centered on the reflection axis HR parallel to the first direction (X-axis direction). That is, since the reflecting device 100b has the reflection axis VR parallel to the second direction (Y-axis direction) and the reflection axis HR parallel to the first direction (X-axis direction), the reflection angle can be controlled in a direction with the reflection axis VR as the axis of rotation and in a direction with the reflection axis HR as the axis of rotation.

FIG. 14 shows an example of the cross-sectional structure of the reflecting element 102 with the switching element 134 connected to the patch electrode 108. The switching element 134 is disposed on the first substrate 104. The switching element 134 is a transistor and has a stacked structure of a first gate electrode 138, a first gate insulation layer 140, a semiconductor layer 142, a second gate insulation layer 146, and a second gate electrode 148. An undercoat layer 136 may be disposed between the first gate electrode 138 and the first substrate 104. The first wiring 118 is disposed between the first gate insulating layer 140 and the second gate insulating layer 146. The first wiring 118 is disposed in contact with the semiconductor layer 142. A first connecting wiring 144 is disposed on the same layer as the conductive layer forming the first wiring 118. The first connecting wiring 144 is disposed in contact with the semiconductor layer 142. The connection structure of the first wiring 118 and the first connecting wiring 144 to the semiconductor layer 142 shows a structure in which one wiring is connected to the source of the transistor and the other wiring is connected to the drain.

A first interlayer insulating layer 150 is disposed to cover the switching element 134. The second wiring 132 is disposed on the first interlayer insulating layer 150. The second wiring 132 is connected to the second gate electrode 148 through a contact hole formed in the first interlayer insulation layer 150. Although not shown in the figure, the first gate electrode 138 and the second gate electrode 148 are electrically connected to each other in a region that does not overlap the semiconductor layer 142. A second connecting wiring 152 is disposed on the first interlayer insulating layer 150 with the same conductive layer as the second wiring 132. The second connecting wiring 152 is connected to the first connecting wiring 144 through a contact hole formed in the first interlayer insulating layer 150.

A second interlayer insulating layer 154 is disposed to cover the second wiring 132 and the second connecting wiring 152. Furthermore, a planarization layer 156 is disposed to fill the steps of the switching element 134. It is possible to form the patch electrode 108 without being affected by the arrangement of the switching element 134 by arranging the planarization layer 156. A passivation layer 158 is disposed over the flat surface of the planarization layer 156. The patch electrode 108 is disposed over the passivation layer 158. The patch electrode 108 is connected to the second connecting wiring 152 through a contact hole formed through the passivation layer 158, the planarization layer 156, and the second interlayer insulating layer 154. The alignment film 112a is disposed over the patch electrode 108.

The second substrate 106 is provided with the common electrode 110 and the alignment film 112b, as in FIG. 1. The surface on which the switching element 134 and the patch electrode 108 of the first substrate 104 are provided is arranged so that the surface on which the common electrode 110 of the second substrate 106 is provided faces the surface switching element 134, and the liquid crystal layer 114 is provided between them.

Each layer formed on the first substrate 104 is formed using the following materials. The undercoat layer 136 is formed, for example, with a silicon oxide film. The first gate insulating layer 140 and the second gate insulating layer 146 are formed, for example, with a silicon oxide film or a laminated structure of a silicon oxide film and a silicon nitride film. The semiconductor layers are formed of silicon semiconductors such as amorphous silicon and polycrystalline silicon, and oxide semiconductors including metal oxides such as indium oxide, zinc oxide, and gallium oxide. The first gate electrode 138 and the second gate electrode 148 may be configured, for example, of molybdenum (Mo), tungsten (W), or alloys thereof. The first wiring 118, the second wiring 132, the first connecting wiring 144, and the second connecting wiring 152 are formed using metal materials such as titanium (Ti), aluminum (Al), and molybdenum (Mo). For example, a titanium (Ti)/aluminum (Al)/titanium (Ti) laminate structure or a molybdenum (Mo)/aluminum (Al)/molybdenum (Mo) laminate structure may be used. The planarization layer 156 is formed of a resin material such as acrylic, polyimide, or the like. The passivation layer 158 is formed of, for example, a silicon nitride film.

As shown in FIG. 14, it is possible to select a predetermined patch electrode from the plurality of patch electrodes 108 arranged in a matrix and apply a control signal to the patch electrode, by connecting the second wiring 132 to the gate of the transistor used as the switching element 134, the first wiring 118 to one of the source and drain of the transistor, and the patch electrode 108 to the other of the source and drain. Then, it is possible to apply a control voltage to each patch electrode 108 arranged in a row along the first direction (x-axis direction) or each patch electrode 108 arranged in a row along the second direction (y-axis direction), by arranging the switching element 134 for each individual patch electrode 108 in the reflector 120, for example, when the reflector 120 is upright, the direction of reflection of the reflected wave can be controlled in the left-right and vertical directions.

As described above, the reflecting device 100 according to an embodiment of the present invention has the plurality of first through-holes 109 in the cross shaped patch electrode 108, the plurality of second through-holes 113 in the common electrode 110 overlapping the patch electrode 108, and the plurality of first through-holes 109 and the plurality of second through-holes 113 overlap each other, so that the reflecting device 100 can be aesthetically pleasing without spoiling the view and can have high reflective properties. Additionally, the reflecting device 100 can control the reflection of radio waves in both the first direction and the second direction which is different from the first direction, enabling the reflection of 5G radio waves in the desired direction.

The embodiments described above as embodiments of the present invention may be combined as appropriate, provided that they do not contradict each other. Furthermore, even if a person skilled in the art appropriately adds or deletes components or modifies designs based on the embodiments, or adds or omits steps or modifies conditions, such additions or deletions are included in the scope of the present invention as long as they include the gist of the present invention.

It is understood that other advantageous effects different from the 5 advantageous effects disposed by the embodiments disclosed herein, which are obvious from the description herein or which can be easily foreseen by a person skilled in the art, will naturally be disposed by the present invention.

What is claimed is:

1. An intelligent reflecting surface, comprising:
a patch electrode,
a common electrode facing the patch electrode and separated from the patch electrode, and
a liquid crystal layer between the patch electrode and the common electrode,
wherein the patch electrode has a cross shape including a first rectangular pattern extending in a first direction and a second rectangular pattern extending in a second direction intersecting the first direction and intersecting the first rectangular pattern in a plan view,
the common electrode has a first striped pattern extending in the first direction and a second striped pattern extending in the second direction and intersecting the first striped pattern in a plan view,
the first rectangular pattern and the second rectangular pattern of the patch electrode overlap the common electrode,
the patch electrode has a plurality of first through-holes in the first rectangular pattern and the second rectangular pattern,
the common electrode has a plurality of second through-holes in the first striped pattern and the second striped pattern, and
the first through-hole and the second through-hole overlap each other.

2. The intelligent reflecting surface according to claim 1,
wherein the plurality of first through-holes and the plurality of second through-holes are rectangular in a plan view, and are arranged along the first direction and the second direction.

3. The intelligent reflecting surface according to claim 2,
wherein the first through-hole is arranged in a plurality of columns in the first rectangular pattern and the second rectangular pattern, and
the second through-hole is arranged in a plurality of columns in the first striped pattern and the second striped pattern.

4. The intelligent reflecting surface according to claim 1, wherein the first through-hole and the second through-hole are arranged to form a checkered pattern.

5. The intelligent reflecting surface according to claim 1,
wherein the plurality of first thorough-holes includes a slit-shaped pattern extending along the first rectangular pattern and the second rectangular pattern, and a dot pattern at an intersection of the first rectangular pattern and the second rectangular pattern, and
the plurality of second through-holes includes a slit-shaped pattern extending along the first striped pattern and the second striped pattern, and a dot pattern at an intersection of the first striped pattern and the second striped pattern.

6. The intelligent reflecting surface according to claim 5,
wherein the slit-shaped pattern is different in size from the dot pattern.

7. The intelligent reflecting surface according to claim 1,
wherein the first striped pattern comprises a plurality of first striped patterns,
the second striped pattern comprises a plurality of second striped patterns,
the common electrode further includes a grid pattern in a plan view, and a plurality of intersections where the plurality of first striped patterns and the plurality of second striped patterns intersect each other,
the grid pattern includes a first straight-line pattern extending in the first direction and a second straight-line pattern extending in the second direction,
a plurality of the first straight-line patterns and the second striped pattern intersect between a plurality of first intersections among the plurality of intersections, and
a plurality of the second straight-line patterns and the first striped pattern intersect between a plurality of second intersections different from the plurality of first intersections.

8. The intelligent reflecting surface according to claim 1,
wherein a plurality of the patch electrodes are arrayed in a matrix, and the plurality of patch electrodes arrayed in a column direction are connected for each array.

9. The intelligent reflecting surface according to claim 1, further comprising,
a transistor that is electrically connected to the patch electrode,
wherein the transistor is provided on a first substrate, and
the patch electrode is provided on a second substrate facing the first substrate.
